(19) United States
(12) Patent Application Publication
(10) Pub. No.: US 2018/0326349 A1
(43) Pub. Date: Nov. 15, 2018

(54) Method for Removing a Nitrogen-Based Compound from a Gas Stream to Produce a Nitrogen-Based Product

(71) Applicants: Stephen R. Temple, Santa Cruz, CA (US); Howard Everett Whitney, Felton, CA (US)

(72) Inventors: Stephen R. Temple, Santa Cruz, CA (US); Howard Everett Whitney, Felton, CA (US)

(21) Appl. No.: 15/977,984

(22) Filed: May 11, 2018

Related U.S. Application Data
(60) Provisional application No. 62/505,809, filed on May 12, 2017.

(51) Int. Cl. B01D 53/14; B01D 53/18; C05C 3/00

(52) U.S. Cl. CPC B01D 53/1412; B01D 53/185; B01D 2258/0266; B01D 2252/103; B01D 2257/406; C05C 3/00

(57) ABSTRACT

The present invention is directed to a process for removing nitrogen-based compounds in a gas stream by absorbing at least a portion of one of those compounds into a liquid stream. The absorbed nitrogen-based compound in the liquid stream is then reacted with a liquid phase chemical compound to produce a nitrogen-based product. The nitrogen-based compound in the gas stream and the liquid phase chemical compound with which the absorbed nitrogen-based compound is reacted may be “organic” compounds, i.e. compounds derived from living organisms, such as from animal matter or plant or vegetable matter, or having animal or plant origins. The nitrogen-based compound in the gas stream may be ammonia. The liquid phase chemical compound may be organic acetic acid or organic citric acid, and the nitrogen-based product may be an organic fertilizer, such as organic ammonium acetate or organic ammonium citrate that may be certified as organic.

### CROSS-REFERENCE TO RELATED APPLICATIONS

This application claims the benefit of provisional Application No. 62/505,809, filed May 12, 2017. The entirety of the foregoing application is incorporated by reference herein.

### BACKGROUND OF THE INVENTION

### Field of the Invention

The invention and its various embodiments relate to a process for removing nitrogen compounds from a gas stream to produce a nitrogen-based product. In particular, the invention and its various embodiments relate to a process for removing nitrogen-based compounds, such as ammonia, from a gas stream using an organically-derived acid to produce an organic ammonium-based product, such as a fertilizer.

### Description of Related Art

Organic agriculture is the production of food from plants and animals through the use of natural or organic resources as opposed to synthetic resources, such as synthetic fertilizers, pesticides, and herbicides. Organic agriculture may also be referred to as organic farming. Generally, organic foods may be labeled as “certified” by meeting certain governmental regulatory criteria for their production, including the avoidance of synthetic chemical inputs, such as the synthetic fertilizers.

Fertilizers that may be used in the production of organic foods would include fertilizers derived from animal matter, such as animal byproducts, animal wastes, and vegetable matter, such as compost and crop residues.

Animal byproduct processing (e.g., rendering) generally consists of converting waste animal tissues into animal feed such as purified animal fats (e.g., lard, tallow, and grease) and protein meal (e.g., meat, feather meal, hair meal, wool meal, bone meal, and blood meal). Generally, byproduct processing is performed by simultaneously drying the animal byproduct and separating the fat from the bone and protein.

For example, in a rendering process, the raw animal material is brought to the plant in trucks and placed into a raw material conveyor that is fed to a grinder where the raw animal material is ground. The ground material is then cooked in a continuous or batch cooker (e.g., disk dryer, evaporator) to evaporate moisture and to separate fat from bone and protein. The resulting material is then separated into liquid fat and solids. The solids are further processed to remove additional moisture and fats (e.g., by using a screw press) resulting in the generation of a press cake that is ultimately made into a meal product.

However, gas streams are also produced during animal byproduct processing. For example, in a rendering process, gas streams are generated at several points, including the unloading, conveyance, and grinding of raw material; the cooking of the ground material; and at other points in the process. These gas streams may contain various chemical compounds including nitrogen-based compounds, such as ammonia.

Typically, these gas streams are collected by a ventilation system and treated by various methods (e.g. spray scrubbing, packed bed wet scrubbing, incineration) to remove various compounds, including certain odorous compounds, before being released to the atmosphere. However, given that some of these gas streams may be relatively rich in nitrogen compounds, such as ammonia, a need exists for a process to recover these nitrogen compounds and to produce a nitrogen-based product, including a saleable nitrogen-based product. Further, a need exists for a process that increases the amount of these nitrogen compounds that can be recovered and to recover these nitrogen compounds to produce a fertilizer product, including one that can be used in organic agriculture or that can be certified as an organic fertilizer, given the non-synthetic origins of the nitrogen compounds in the gas streams. Further, a general need exists for a process to recover nitrogen-based compounds from any gas stream, including an anaerobic digester, in which the nitrogen-based compounds have an organic origin, to produce a fertilizer product, including one that can be used in organic agriculture or that can be certified as an organic fertilizer or that is approved for use in certified “organic” farming or agriculture.

### BRIEF SUMMARY OF THE INVENTION

In general, the present invention is directed to a process for removing nitrogen-based compounds in a gas stream by absorbing at least a portion of one of those compounds into a liquid stream. The absorbed nitrogen-based compound in the liquid stream is then reacted with a liquid phase chemical compound to produce a nitrogen-based product. In particular, the nitrogen-based compound in the gas stream and the liquid phase chemical compound with which the absorbed nitrogen-based compound is reacted may be “organic” compounds, i.e. compounds derived from living organisms, such as from animal matter or plant or vegetable matter, or having animal or plant origins, or derived from the earth or naturally occurring compounds, as opposed synthetic compounds, such as petrochemicals and petrochemical-derived compounds (e.g. Haber-Bosch ammonia process).

Accordingly, in some embodiments, the nitrogen-based product that is produced through the reaction of the absorbed nitrogen-based compound and the liquid phase chemical compound produces an organic nitrogen-based product that may be used, for example, in the production of “organic” foods. In some embodiments, the nitrogen-based compound in the gas stream is ammonia. In some embodiments, the liquid phase chemical compound with which the absorbed nitrogen-based compound reacts is an organic or naturally fermented or naturally occurring acid, such as formic, acetic, butyric, citric, and humic acids, etc. Accordingly, in some embodiments, the nitrogen-based product may be a fertilizer, in particular, an organic fertilizer, such as organic ammonium acetate or organic ammonium citrate or an organic fertilizer that may be certified as organic and used, for example, in the production of organic foods.

### BRIEF DESCRIPTION OF THE SEVERAL VIEWS OF THE DRAWINGS

FIG. 1 is a process flow diagram for removing nitrogen-based compounds from a gas stream and producing a nitrogen-based product according to one embodiment of the present invention; and

FIG. 2 is a process flow diagram for removing nitrogen-based compounds from a gas stream and producing a nitrogen-based product according to one embodiment of the present invention.

### DETAILED DESCRIPTION OF THE INVENTION

The present invention is more fully described below with reference to the accompanying drawings. While the invention will be described in conjunction with particular embodiments, it should be understood that the invention can be applied to a wide variety of applications, and it is intended to cover alternatives, modifications, and equivalents within the spirit and scope of the invention. Accordingly, the following description is exemplary in that several embodiments are described (e.g., by use of the terms “preferably,” “for example,” or “in one embodiment”), but this description should not be viewed as limiting or as setting forth the only embodiments of the invention, as the invention encompasses other embodiments not specifically recited in this description. Further, the use of the terms “invention,” “present invention,” “embodiment,” and similar terms throughout this description are used broadly and are not intended to mean that the invention requires, or is limited to, any particular aspect being described or that such description is the only manner in which the invention may be made or used.

In general, the present invention is directed to a process for removing nitrogen-based compounds in a gas stream by absorbing at least a portion of one of those compounds into a liquid stream. The absorbed nitrogen-based compound in the liquid stream is then reacted with a liquid phase chemical compound to produce a nitrogen-based product.

In some embodiments, the nitrogen-based compound in the gas stream and the liquid phase chemical compound with which the absorbed nitrogen-based compound is reacted may be “organic” compounds. It should be appreciated that the term “organic” is used with reference to compounds derived from living organisms, such as from animal matter or plant or vegetable matter, or having earth, animal, or plant origins, such as naturally occurring compounds, as opposed to synthetic compounds and as opposed to the traditional chemical classification used in reference to compounds containing carbon (e.g., the branch of “organic” chemistry). For example, “organic” compounds includes, but is not limited to, compounds that may be used in the production of “organic” foods. Accordingly, in some embodiments, the nitrogen-based product that is produced through the reaction of the absorbed nitrogen-based compound and the liquid phase chemical compound produces an organic nitrogen-based product. In some embodiments, the nitrogen-based compound in the gas stream is ammonia. In some embodiments, the liquid phase chemical compound with which the absorbed nitrogen-based compound reacts is acetic acid or citric acid. In some cases, the acetic acid is produced by fermentation and in some cases may be an organic acetic acid. In some cases, the citric acid may be an organic citric acid. In some embodiments, the acid may be an organic acid, such as formic, acetic, butyric, citric, or humic acid. Accordingly, in some embodiments, the carbon-13 signature of the nitrogen-based product will be different depending upon whether an organic acid was used compared to a synthetically derived acid. In some embodiments, it should be appreciated that the nitrogen-based product may be a fertilizer, in particular, an organic fertilizer, such as organic ammonium acetate or organic ammonium citrate. Accordingly, in some embodiments, the carbon-13 signature of the fertilizer will be different compared to a fertilizer produced using a synthetically derived acid. In some embodiments, however, it should be appreciated that one or both of the nitrogen-based compound in the gas stream and the liquid phase chemical compound with which the absorbed nitrogen-based compound is reacted may not be organic.

While it should be appreciated that the invention may be used with any gas stream containing a nitrogen-based compound and any liquid phase chemical compound that reacts with the corresponding absorbed nitrogen-based compound to produce a nitrogen-based product, the invention has particular application in using a gas stream containing an organic nitrogen-based compound and a liquid stream containing an organic liquid phase chemical compound that reacts with the corresponding nitrogen-based compound being absorbed to produce an organic nitrogen-based product, such as an organic fertilizer that may be certified for use in organic agriculture. In some embodiments, the organic nitrogen-based compound in the gas stream is ammonia produced by an animal byproduct process, such as a rendering process. In some embodiments, the liquid phase chemical compound with which the absorbed nitrogen-based compound reacts is organic or non-synthetic acetic acid, such as a vinegar produced through fermentation of agricultural raw materials. In this case, the nitrogen-based product is an organic ammonium acetate, such as an ammonium acetate fertilizer product. In some embodiments, the liquid phase chemical compound with which the absorbed nitrogen-based compound reacts is organic or non-synthetic citric acid, which may, for example, be fermented from natural materials, such as extracted from citrus fruits. In this case, the nitrogen-based product is an organic ammonium citrate, such as an ammonium citrate fertilizer product.

Further, it should be appreciated that in some embodiments, the gas stream is a gas stream derived from or produced by a process that also produces the nitrogen-based compound in that gas stream. In some embodiments, the gas stream containing the nitrogen-based compound is produced from an animal byproduct process. In general, any bio-gas containing nitrogen-based compounds, such as ammonia, may be used. For example, gas streams produced through decomposition, fermentation, hydrolysis, anaerobic digestion, or by increasing the pH of animal matter, or plant matter, may be used. It should be appreciated that the concentration of the nitrogen-based compound, such as ammonia, in the gas stream may be increased by changing the operation of the process applied to the animal or plant matter. For example, a longer decomposition process followed by hydrolysis and anaerobic digestion of the oil or solid by-product can produce an additional ammonia in the gas stream without transitioning into methanogenesis. Anaerobic digestion also produces volatile fatty acids, such as acetic acid, on which the ammonia can be concentrated or sequestered.

These and other aspects of the present invention are described below in connection with the Figures. However, it should be appreciated that the following describes the invention in terms of specific embodiments, which, as noted above, should not be interpreted as limiting the overall scope of the invention as it can be applied in a wide variety of applications and with various features that may or may not be explicitly described in connection with the Figures.

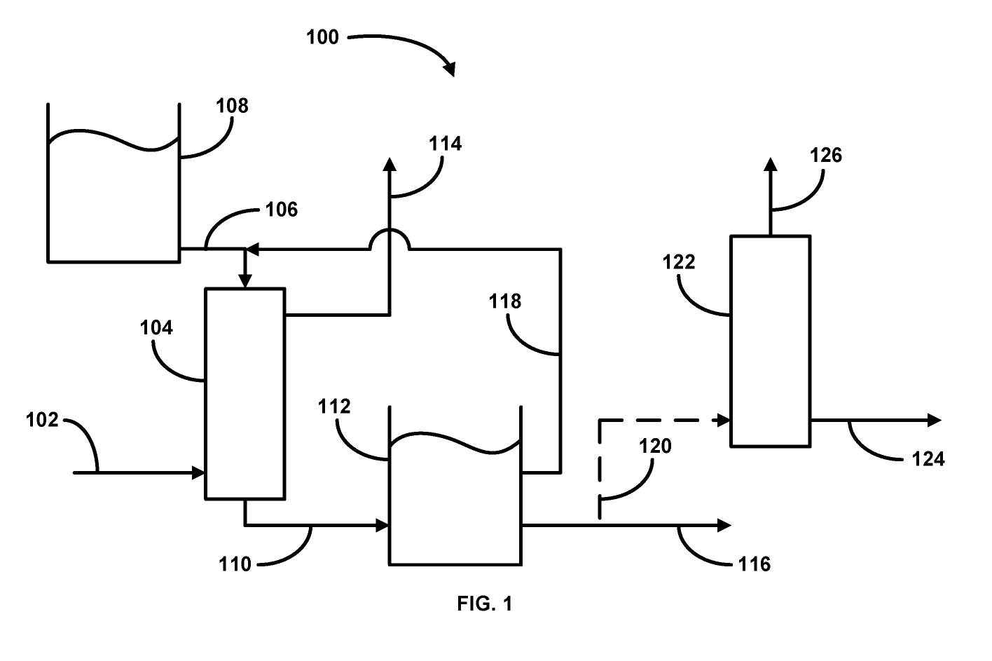

FIG. 1 is a process flow diagram for removing nitrogen-based compounds from a gas stream and producing a nitrogen-based product according to one embodiment of the present invention. In general, the process 100 includes a gas stream 102 having at least one nitrogen-based compound, such as ammonia, is passed to a gas/liquid contactor 104 in which the gas stream 102 will contact a liquid feed stream or absorbing solution 106 that is fed to the gas/liquid contactor 104 and into which the nitrogen-based compound in the gas stream 102 is absorbed. The liquid feed stream 106 contains a liquid phase chemical compound that reacts with the absorbed nitrogen-based compound from the gas stream 102 to produce, or to further the production of, a desired nitrogen-based product. Following is a more detailed description of the process shown in FIG. 1.

The gas stream 102 may be any gas stream having at least one nitrogen-based compound, such as ammonia. For example, the gas stream 102 may be any industrial or process gas stream containing at least one nitrogen-based compound, such as ammonia. It should be appreciated that the gas stream 102 may be multiple gas streams or separate gas streams that are separately fed to the gas/liquid contactor 104. The gas stream 102 may also be a composite of individual gas streams or a single gas stream that is a collection of gas streams or vapors. In some embodiments, the gas stream 102 is a gas stream containing an organic nitrogen-based compound, such as organic ammonia. Accordingly, in this case, the organic nitrogen-based compound is derived from earth, animal, or plant matter. In some embodiments, the organic nitrogen-based compound in the gas stream 102 may be ammonia produced by an animal byproduct process. For example, the gas stream 102 may be a gas stream or collection of vapors generated by decomposition, fermentation, hydrolysis, anaerobic digestion, or by increasing the pH of animal or plant matter. The gas stream 102 may be a gas stream, multiple gas streams, or a collection of vapors generated from an animal by product process, such as a rendering process. In one embodiment, the gas stream 102 is a gas stream produced from a rendering process, including, for example, one or more or a collection of gases or vapors collected from various process operations within the rendering process. In particular, the gas stream 102 may be one or more or a collection of vapors generated at several points in the rendering process, including the unloading, conveyance, and grinding of raw material; the cooking of the ground material; and other points in the rendering process.

In some embodiments, it should be appreciated that the gas stream 102 may also include one or more gas streams containing nitrogen-based compounds obtained by stripping various liquid phase streams. In general, any liquid stream containing nitrogen compounds that could be recovered may be stripped by any method known in the art to produce a gas stream containing the stripped nitrogen-based compounds or their corresponding gaseous form. In this case, the gas stream containing the stripped nitrogen-based compound may constitute the gas stream 102 that is treated as described herein to product a nitrogen-based product, or the gas stream containing the stripped nitrogen-based compound may be combined with other gas streams to provide a single gas stream that constitutes the gas stream 102 that is treated as described herein to product a nitrogen-based product. For example, various liquid streams produced through the treatment of animal processing byproducts and waste, such as liquid streams generated in a rendering process or in bone gelatin production, may contain nitrogen-based compounds that can be stripped and processed according to the present invention. Such liquid streams may include various centrate or condensate streams, such as blood processing centrate and sludge processing condensate, or condensate streams generated by a cooker, a dryer, or a hydrolyzer used in a rendering process.

It should be appreciated that the gas stream 102 may be any bio-gas that can be produced or recovered from any material that results in the bio-gas containing nitrogen-based compounds. For example, various liquid and solid streams produced through the treatment of animal processing byproducts and waste, such as liquid and solid streams generated in a rendering process or in bone gelatin production, may contain nitrogen-based compounds that can be decomposed, fermented, or anaerobically digested and processed according to the present invention. In some embodiments, it should be appreciated that ammonia compounds from decomposition, fermentation, anaerobic digestion, or increased pH of animal or plant matter may be enhanced through inoculation using ammonia-hyperproducing bacteria. Such liquid and solid streams may include raw input material, meals, fats, various centrate or condensate streams such as blood processing centrate and sludge processing condensate, or condensate streams generated by a cooker, a dryer, or a hydrolyzer used in a rendering process.

As noted, the gas stream 102 may also be derived from the decomposition, fermentation, hydrolysis, anaerobic digestion, or by increasing the pH of animal or plant matter. However, in these cases, it should also be appreciated that concentration of the nitrogen-based compound in the resulting gas stream from these processes may be increased by altering these processes. For example, by increasing the decomposition, fermentation, hydrolysis, or anaerobic digestion time, or by raising the pH of the animal or plant matter, additional nitrogen-based compounds, such as ammonia, may be generated resulting in a higher concentration of the nitrogen-based compound, such as ammonia, in the gas stream 102 that is fed to the gas/liquid contractor 104. This will result in higher production of the nitrogen-based product. In some embodiments, by extending the time for decomposition, followed by hydrolysis and anaerobic digestion of the animal or plant matter, without transitioning the process to methanogenesis, additional ammonia gas will be produced. For example, by extending the decomposition process followed by hydrolysis and anaerobic digestion of the oil or solid byproduct, additional ammonia gas can be produced without transitioning into methanogenesis. Anaerobic digestion also produces volatile fatty acids, such as acetic acid, on which the ammonia can be concentrated or sequestered. In some embodiments, spent lime or other caustic wasterwater or sludge may be fed into the raw materials from which the gas containing the nitrogen-based compound is derived, may increase the release of nitrogen-based compounds from the raw materials, thereby increasing the amount of nitrogen-based compounds ultimately present in the gas stream 102.

The liquid feed stream 106 is a solution that will absorb the nitrogen-based compound in the gas stream 102, thereby concentrating the absorbed nitrogen-based compound in the liquid stream 106. Accordingly, depending upon the composition and concentration of the nitrogen-based compound in the gas stream 102 and the volumetric flow rate of the gas stream 102 to the gas/liquid contactor 104, the amount of the nitrogen-based compound in the gas stream 102 that is to be absorbed into the liquid stream 106 in the gas/liquid contactor 104, the volumetric flow rate of the liquid feed stream 106 to the gas/liquid contactor 104, and the design of the gas/liquid contactor 104, the composition of the liquid feed stream 106 can be determined. In addition, other parameters of the liquid feed stream 106 may be adjusted depending upon the various operating parameters described above. For example, pH adjustments to the liquid feed stream 106 may be made to optimize absorption of the nitrogen-based compound in the gas stream 102, which can be done by pH control using a feedback or feedforward control system. Also, temperature adjustments may be made to the liquid feed stream 106. The liquid feed stream 106 could be cooled or chilled to increase the absorption of the nitrogen-based compound from the gas stream 102. In some embodiments, the liquid feed stream 106 could be cooled to temperatures less than ambient, such as below 15° C. or below 60° C. Alternatively, the liquid feed stream 106 may be warmed or heated to decrease the absorption of water vapor with the nitrogen-based compound from the gas stream 102. In some embodiments, the liquid feed stream 106 may be heated to temperatures greater than ambient, such as above 15° C. or above 60° C.

In addition, the liquid feed stream 106 contains the liquid phase chemical compound that is any chemical that will react with the absorbed nitrogen-based compound from the gas stream 102 to produce, or to further the production of, the desired nitrogen-based product. For example, in some embodiments, the liquid phase chemical compound is a liquid phase chemical compound that reacts with the absorbed nitrogen-based compound to produce a nitrogen-based product, such as a fertilizer. In some embodiments, the liquid phase chemical compound is an organic or natural, non-synthetic compound (i.e., a compound derived from earth, animal, or plant matter), including a compound approved for use in organic food production.

In this case, it is possible to utilize the process of the present invention to produce an organic nitrogen-based product, such as an organic fertilizer that may be labeled and sold as a certified/listed/registered “organic” and, for example, may be certified for a number of uses in organic agriculture. For example, in some embodiments in which that nitrogen-based compound in the gas stream 102 is an organic compound (i.e., a compound derived from earth, animal, or plant matter), the use of an organic liquid phase chemical compound may be used to produce an organic nitrogen-based product, such as an organic fertilizer that may be labeled and sold as a certified/listed/registered “organic” and, for example, may be certified for a number of uses in organic agriculture. In some embodiments in which the organic nitrogen-based compound in the gas stream 102 is ammonia produced by an animal byproduct process, such as a rendering process, the liquid phase chemical compound that reacts with the absorbed nitrogen-based compound or absorbed ammonia is an organic acid that upon reaction produces an organic nitrogen-based product, such as an organic fertilizer, starter fertilizer, foliar fertilizer, seed treatment, bio-stimulant for natural or applied soil bacteria, anti-scalant, buffer solution, protein precipitator, protein purifier, etc. that may be certified/listed/registered as organic and, for example, may be certified for a number of uses in organic agriculture.

In some embodiments in which the liquid phase chemical compound is organic, the liquid phase chemical compound is acetic acid (i.e., the active ingredient in vinegar) produced through fermentation of natural raw materials, such as agricultural raw materials. The production of organic acetic acid, including organic acetic acid that is certified/listed/registered “organic” and approved for use in organic agriculture, can be done using grains such as corn or other agricultural raw materials such as cane sugar, which are then fermented into alcohol and then into acetic acid. Fleischmann's produces two products using this general method of production, Fleischmann's Vinegar White Distilled Vinegar and Fleischmann's Vinegar Organic White Distilled Vinegar, the latter being produced from only certified organic materials. Carbon 13 testing can be used to determine whether the vinegar originates from agricultural materials or fossil fuels and is, therefore, organic, as opposed to synthetically produced acetic acid. In using acetic acid when the nitrogen-based compound in the gas stream 102 is organic ammonia, the nitrogen-based product is an organic ammonium acetate, such as an organic ammonium acetate fertilizer product. In some embodiments, the concentration of acetic acid in the solution held in the liquid feed tank 108 may be approximately 30% by weight. In some embodiments, the concentration of acetic acid in the solution held in the liquid feed tank 108 may be greater than 30% by weight. In some embodiments, the concentration of acetic acid in the solution held in the liquid feed tank 108 may be greater than 80% by weight. It should be appreciated that in using an organic acetic acid or a naturally sourced fermented acetic acid, in some embodiments, the carbon-13 signature of the nitrogen-based product or fertilizer will be different compared to a fertilizer produced using synthetically derived acetic acid.

In some embodiments, the organic acid, including an acid approved for use in organic agriculture, may be citric acid, which may, for example, be extracted from citrus fruits or created by cultured sugars. In this case, the nitrogen-based product is an organic ammonium citrate, such as an ammonium citrate fertilizer product. In some embodiments, other organic acids, including acids approved for use in organic agriculture, may be selected to generate other nitrogen-based products.

The liquid feed stream 106 is held in a liquid feed tank 108 that may be any vessel capable of holding the solution of the liquid phase chemical compound for feeding to the gas/liquid contactor 104. In operation, the liquid feed stream 106 containing the liquid phase chemical compound is fed to the gas/liquid contactor 104. Therefore, the liquid feed tank 108 will need to be replenished with fresh solution of the liquid phase chemical compound by any method known in the art to provide an adequate supply of the solution of the liquid phase chemical compound to the gas/liquid contactor 104. Depending upon the concentration of the nitrogen-based compound in the gas stream 102 and the volumetric flow rate of the gas stream 102 to the gas/liquid contactor 104, the amount of the nitrogen-based compound in the gas stream 102 that is absorbed, or desired to be absorbed, into the liquid stream 106 in the gas/liquid contactor 104, and the design of the gas/liquid contactor 104, including the amount of liquid that can be fed to the gas/liquid contactor 104 and the concentration of the liquid phase chemical compound in the liquid feed tank 108, the necessary corresponding volumetric flow rate of the liquid feed stream 106 to the gas/liquid contactor 104 can be determined.

The gas/liquid contactor 104 may be any equipment used to bring a gas stream and a liquid stream into contact. For example, the gas/liquid contactor 104 may be a spray tower, a tray tower, a venturi, a bubbler, a selective membrane separator, and combinations thereof. In operation, the gas/liquid contactor 104 brings the gas stream 102 into contact with the liquid feed stream 106 containing the solution of the liquid phase chemical compound. As a result, the nitrogen-based compound in the gas stream 102 is absorbed into the liquid feed stream 106. The liquid feed stream 106 is then discharged from the gas/liquid contactor 104 as a liquid discharge stream 110. The gas stream 102 is also discharged from the gas/liquid contactor 104 as a gas discharge stream 114, which may be further processed as necessary or discharged to the atmosphere. Further processing of the gas discharge stream 114 may include passing the gas through condensing equipment, such as a reflux condenser, or a process for condensing a gas stream to ensure that any volatiles that were not previously absorbed or that were flashed in the gas/liquid contactor 104 are removed or reduced prior to gas discharge to the atmosphere as desired.

Upon absorption of the nitrogen-based compound in the gas stream 102 into the liquid feed stream 106, the liquid phase chemical compound will react with the absorbed nitrogen-based compound to produce the desired nitrogen-based product. This reaction may occur immediately upon absorption within the gas/liquid contactor and may continue in the liquid phase in the liquid discharge stream 110. The liquid discharge stream 110 is passed to a holding tank 112 that provides two functions. One, the holding tank 112 acts to collect the liquid discharge stream 110 and the nitrogen-based product, and two, the holding tank 112 provides additional residence time, if needed, for the reaction of the liquid phase chemical compound to react with the absorbed nitrogen-based compound to produce additional nitrogen-based product.

A product stream 116, which is a solution containing the nitrogen-based product, is passed from the holding tank 112 for use. For example, a given quantity of the product stream 116 can be passed to any type of vehicle designed to carry liquid, which can then be taken to a storage facility for later sale or directly to an end user for storage or use.

Optionally, a liquid recycle stream 118 may be passed from the holding tank 112 back to the gas/liquid contactor 104. In this case, the liquid recycle stream 118 may be combined with the liquid feed stream 106 prior to entering the gas/liquid contactor 104. One of skill in the art will appreciate whether the liquid recycle stream 118 requires any treatment, such as pH or temperature adjustment, prior to its addition to the liquid feed stream 106. The flow rate of the liquid recycle stream 118 can be adjusted based upon the overall water balance for the process and, accordingly, as determined by the amount of the nitrogen-based product being discharged through the product stream 116.

Since the product stream 116 contains water, it may optionally be concentrated through the removal of a portion of the water. For example, the product stream 116 may optionally be sent to a distillation tower 122 to evaporate a portion of the water in the product stream 116. The product stream 116 after having a portion of the water removed is discharged from the distillation tower 122 as a concentrated product stream 124. This concentrated product stream 124 may be utilized in the same manner as the product stream 116 that is discharged from the holding tank 112 as described above. The evaporated water is discharged from the distillation tower 122 as a gas discharge stream 126 and may be discharged to the atmosphere or further processed if necessary before being discharged to the atmosphere. In some embodiments, the product stream 116 may optionally be processed to remove a significant portion or all of the water to produce a solid nitrogen-based product (not shown). In some embodiments, the product may be further processed to produce a dry nitrogen-based product (not shown).

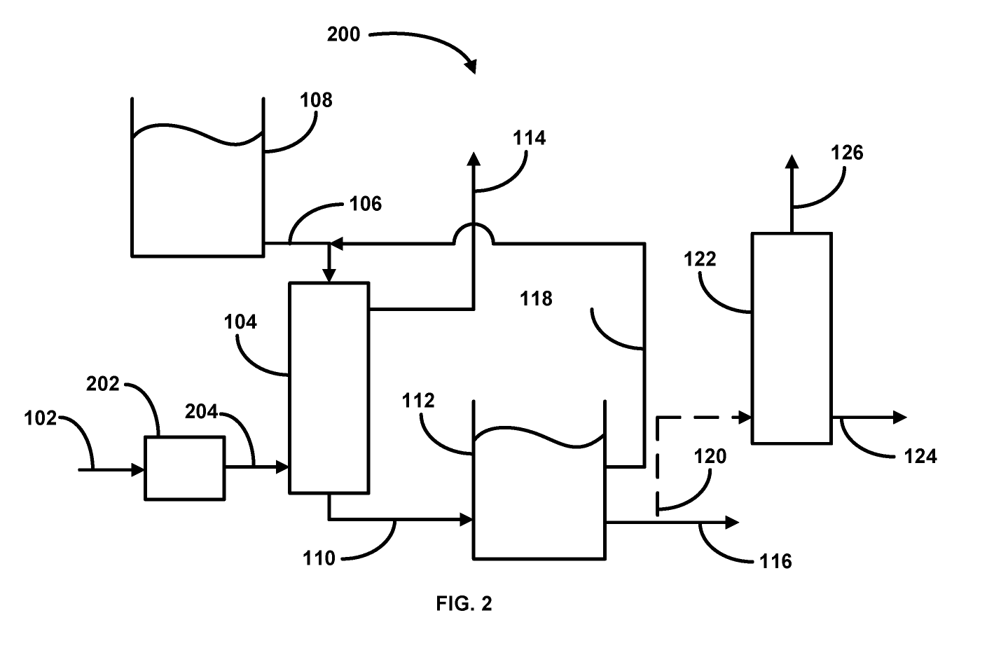

FIG. 2 is a process flow diagram for removing nitrogen-based compounds from a gas stream and producing a nitrogen-based product according to one embodiment of the present invention. The process 200 illustrated in FIG. 2 is the same as that shown in FIG. 1 with the exception that the gas stream 102, which as described above may be one or more gas streams or a collection of one or move gas streams or vapors, is first passed to a condenser 202 that is used to condense and remove certain contaminants and water vapor contained in the gas stream 102 to produce a condensed gas stream 204 that is passed to the gas/liquid contactor 104 for removal of the nitrogen-based compounds in the gas stream 204.

Various embodiments of the invention have been described above. However, it should be appreciated that alternative embodiments are possible and that the invention is not limited to the specific embodiments described above. For example, although reference is made to gas streams containing nitrogen-based compounds from animal byproduct processing, such as rendering, the processes described above can be used in connection with any liquid stream containing nitrogen compounds that can be absorbed to generate a nitrogen-based product, and in particular, an organic nitrogen-based products, such as a fertilizer that can be certified as organic for use, for example in organic agriculture.

What is claimed is:

1. A process for removing a nitrogen-based compound from a gas stream, comprising:
absorbing a gas phase nitrogen-based compound in a gas stream into a liquid stream, thereby producing an absorbed nitrogen-based compound;
reacting the absorbed nitrogen-based compound with an organic acid to produce an organic nitrogen-based product.

2. The process of claim 1, wherein the gas phase nitrogen-based compound in a gas stream is an organic compound comprising ammonia.

3. The process of claim 2, wherein the organic nitrogen-based product comprises an organic fertilizer.

4. The process of claim 1, further comprising:
generating the gas stream by processing animal or plant matter to produce a gas containing the gas phase nitrogen-based compound from.

5. The process of claim 4, further comprising:
increasing a concentration of the gas phase nitrogen-based compound in the gas by altering the processing of the animal or plant matter.

6. The process of claim 5, wherein altering the processing of the animal or plant matter comprises increasing a decomposition time of the animal or plant matter and avoiding methanogenesis.
